(19) United States
(12) Patent Application Publication
(10) Pub. No.: US 2018/0320430 A1
(43) Pub. Date: Nov. 8, 2018

(54) COMPLETELY HIDDEN IMPACT-FREE GENTLY POSITIONED DOOR OPENING AND CLOSING STRUCTURE FOR SHOWER ROOM

(71) Applicant: Foshan Ideal Co., Ltd., Foshan (CN)

(72) Inventor: Wuxiang Wei, Foshan (CN)

(73) Assignee: Foshan Ideal Co., Ltd., Foshan (CN)

(21) Appl. No.: 15/540,215

(22) PCT Filed: Jan. 29, 2016
(86) PCT No.: PCT/CN2016/072679

§ 371 Date: Jun. 27, 2017

(51) Int. Cl. E05F 5/00; E05F 5/02

(52) U.S. Cl. CPC E05F 5/003; E05Y 2900/114; E05F 5/027

(57) ABSTRACT

A completely hidden impact-free gently positioned door opening and closing structure for a shower room is disclosed. The door opening and closing structure for the shower room comprises a movable door piece, a rail assembly, pulley assemblies and a flexible closer assembly, wherein the rail assembly comprises a rail having a sliding channel disposed therein, each of the pulley assemblies comprises a pulley base fixed on the movable door piece and a pulley mounted on the pulley base, and the pulley is rollably disposed in the sliding channel; wherein the flexible closer assembly is fixed to the movable door piece, and movably disposed in the sliding channel; the flexible closer assembly comprises a fixing support and flexible closers provided with bayonets, and the flexible closers are fixed on the fixing support; and the rail assembly also comprises positioning elements matched with the flexible closers.

### TECHNICAL FIELD

The present invention relates to the technical field of shower doors, and more particularly, to the sliding of movable door pieces in shower doors and the impact-free gentle positioning of opening/closing doors, especially to a completely hidden impact-free gently positioned door opening and closing structure for a shower room.

### BACKGROUND ART

In existing sliding shower doors, due to inertia factors, when movable door pieces slide along rails to conduct door opening and closing operations, they would normally be subject to impact when opening to the largest position and closing. Flexible closers applied on sliding shower doors are able to solve the impact problem to a certain extent through buffering effects. However, in the shower room in which the prior design is applied, flexible closers are typically mounted on rails, with their bayonets exposed to the outside. Furthermore, additional touching blocks are required to be disposed on the movable door piece so as to actuate the flexible closers. In such a case, elements exposed to the outside would exert negative influences on the appearance of the shower room, thus bringing users poor use experience.

### SUMMARY OF THE INVENTION

The technical problem to be solved by the present invention is to provide a completely hidden impact-free gently positioned door opening and closing structure for a shower room in view of the above drawbacks existing in the prior art.

In order to solve the above technical problem, the following technical solution is adopted in the present invention: a completely hidden impact-free gently positioned door opening and closing structure for a shower room is designed, which comprises: a movable door piece, a rail assembly, a pulley assembly and a flexible closer assembly, wherein the rail assembly comprises a rail having a sliding channel disposed therein, the pulley assembly comprises a pulley base fixed on the movable door piece and a pulley mounted on the pulley base, and the pulley is rollably disposed in the sliding channel; wherein the flexible closer assembly is fixed to the movable door piece, and movably disposed in the sliding channel; the flexible closer assembly comprises a fixing support and a flexible closer provided with a bayonet, and the flexible closer is fixed on the fixing support; the rail assembly also comprises a positioning element matched with the flexible closer.

A further technical solution is as follows: the sliding channel may be formed into an elongated channel with a substantially rectangular cross-section by the encircling of an upper wall, a lower wall, a front wall and a rear wall of the rail, wherein an opening is formed in the rear wall for allowing a bending plate on the pulley base to pass therethrough, an elongated hole is formed in the upper wall for mounting the positioning element, and both ends of the elongated hole are provided with screw holes for fixing the positioning element; both ends of the upper wall are provided with connecting holes for fixing the rail, and the front wall and the rear wall extend downward respectively to form an open channel for mounting a fixed door piece and a waterproof seal.

A further technical solution is as follows: the positioning element may comprise a sheet-like body and a positioning boss extending downward from the middle part of the sheet-like body, wherein the sheet-like body is provided thereon with strip holes that are located at both sides of the positioning boss and used for fixing the positioning elements to the rail; the sheet-like body is in contact with the upper wall, and the positioning boss extends into the sliding channel from the elongated hole, and can be in contact with and coupled to the bayonet of the flexible closer.

A further technical solution is as follows: the fixing support may be connected and fixed to the pulley base, and located between two of the pulley bases. The pulley base may comprise a plate-like body and a bending plate extending from a surface on one side of the body, wherein the pulley is mounted on the bending plate, and a screw hole is disposed on the bending plate for mounting the pulley; the bending plate is provided with positioning bosses at both sides of the pulley, and mounting holes are disposed in the positioning bosses for connecting the fixing support.

A further technical solution is as follows: the fixing support may be elongated, which is formed into a square tube by the encircling of an upper wall, a lower wall, a front wall and a rear wall, and a cavity is formed within the square tube, wherein a notch is formed in the upper wall for placing the flexible closer into the cavity, and a connecting hole is disposed in the front wall for connecting and fixing the flexible closer; both ends of the fixing support are provided with connecting holes for connecting and fixing the fixing support to the pulley bases.

A further technical solution is as follows: the flexible closer may be provided with connecting holes for connecting and fixing to the fixing support, and bayonet is disposed on the surface of the flexible closer, wherein the size of the bayonet corresponds to that of the positioning bosse of the positioning element, and when the positioning bosse of the positioning element is in contact with and coupled to the bayonet, the flexible closer acts to achieve gentle positioning.

A further technical solution is as follows: the flexible closer may comprise a flexible closer for door closing and/or a flexible closer for door opening.

A further technical solution is as follows: the pulley base may be fixed on the movable door piece via an adhesive or a mechanical fastener.

As can be seen from the above technical solutions, for the door opening and closing structure for the shower room in the present invention, the flexible closer assembly and pulleys on a pulley assembly are movable within the sliding channel of the rail, and the bending plate on the pulley base passes through the opening in the rear wall of the rail, such that the pulleys and the flexible closer assembly are hidden in the sliding channel of the rail. When a movable door piece moves to a certain position along the closing direction, a bayonet of the flexible closer for door closing will be in contact with and coupled to a positioning boss of the positioning element for door closing mounted on the rail so as to make the flexible closer for door closing act to prevent the movable door piece from moving at a high speed and make it close up automatically at a low speed. Similarly, when a movable door piece is moved by an external force to a certain position along the door opening direction, a bayonet of the flexible closer for door opening will be in contact with and coupled to a positioning boss of the positioning element for door opening mounted on the rail so as to make the flexible closer for door opening act to prevent the movable door piece from moving at a high speed and make it reach the door opening position automatically at a low speed. According to actual needs, it is possible to only dispose the flexible closer for door closing or the flexible closer for door opening, or it is possible to dispose a bidirectional gently positioned door opening and closing structure. Accordingly, the shower door assembly in which the door opening and closing structure of the present invention is applied can achieve aesthetically pleasing and impact-free gentle positioning.

### BRIEF DESCRIPTION OF THE DRAWINGS

FIG. 1 is a schematic view illustrating the application of the door opening and closing structure for a shower room of the present invention in a shower room.

FIG. 2 is an exploded schematic view illustrating the components of a door opening and closing structure for the shower room in accordance with an embodiment of the present invention.

FIG. 3 is a schematic view illustrating the structure of a rail assembly of the door opening and closing structure for the shower room as shown in FIG. 2, which illustrates the disassembling and assembling states of the rail assembly, respectively.

FIG. 4 is an exploded schematic view illustrating a flexible closer assembly of the door opening and closing structure for the shower room as shown in FIG. 2.

FIG. 5 is a schematic view illustrating the assembly between pulley bases and the flexible closer assembly of the door opening and closing structure for the shower room as shown in FIG. 2.

FIG. 6 is a schematic view illustrating the fixing of the pulley bases and the flexible closer assembly of the door opening and closing structure for the shower room as shown in FIG. 2 to a movable door piece.

FIG. 7 is a schematic view illustrating the sliding of the movable door piece of the door opening and closing structure for the shower room as shown in FIG. 2 along a rail to contact and actuate flexible closers.

FIG. 8 is a schematic view illustrating a door opening and closing structure for the shower room in accordance with an embodiment of the present invention, wherein only the flexible closer for door closing is disposed.

FIG. 9 is a schematic view illustrating a door opening and closing structure for the shower room in accordance with an embodiment of the present invention, wherein only the flexible closer for door opening is disposed.

### DETAILED DESCRIPTION OF THE INVENTION

Various embodiments of the present invention will be described below in detail. Examples therein will be illustrated in combination with the accompanying drawings, and described in the text that follows. The above drawings omit other elements which exert no influence on the protection scope of the claims of the present application. Although the present invention will be described in combination with exemplary embodiments, it should be understood that the present invention is not limited to these exemplary embodiments. Rather, the present invention includes not only these embodiments, but also various variations and improvements.

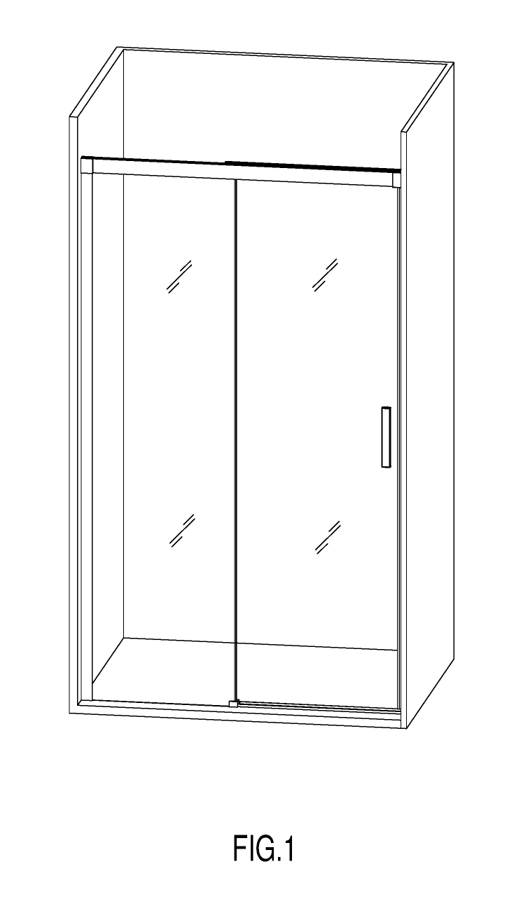

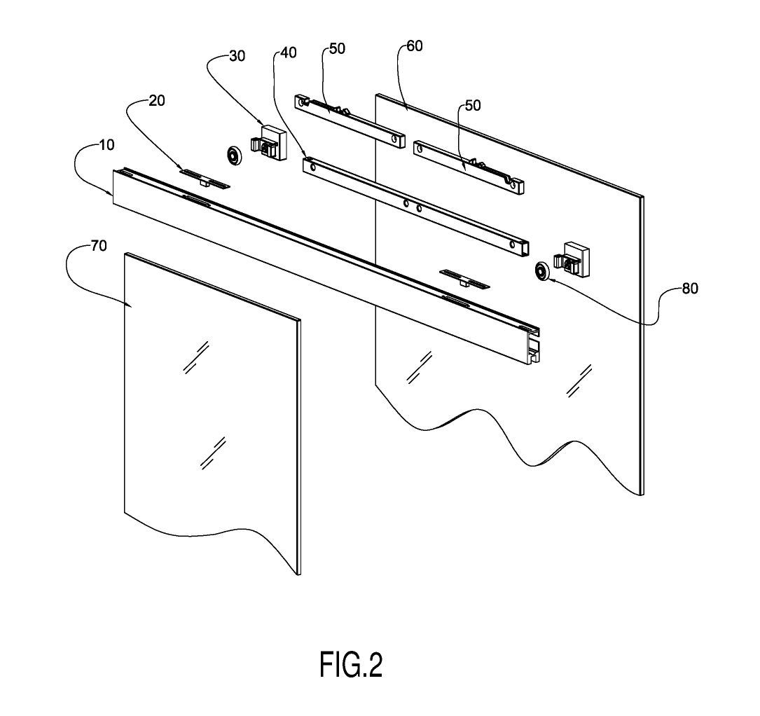

FIG. 1 illustrates the application position of the door opening and closing structure for a shower room of the present invention in a shower room. An embodiment of the door opening and closing structure for the shower room of the present invention is shown in FIG. 2, which comprises: a movable door piece 60, a fixed door piece 70, a rail assembly, pulley assemblies fixed on the movable door piece 60 and a flexible closer assembly mounted between the pulley assemblies.

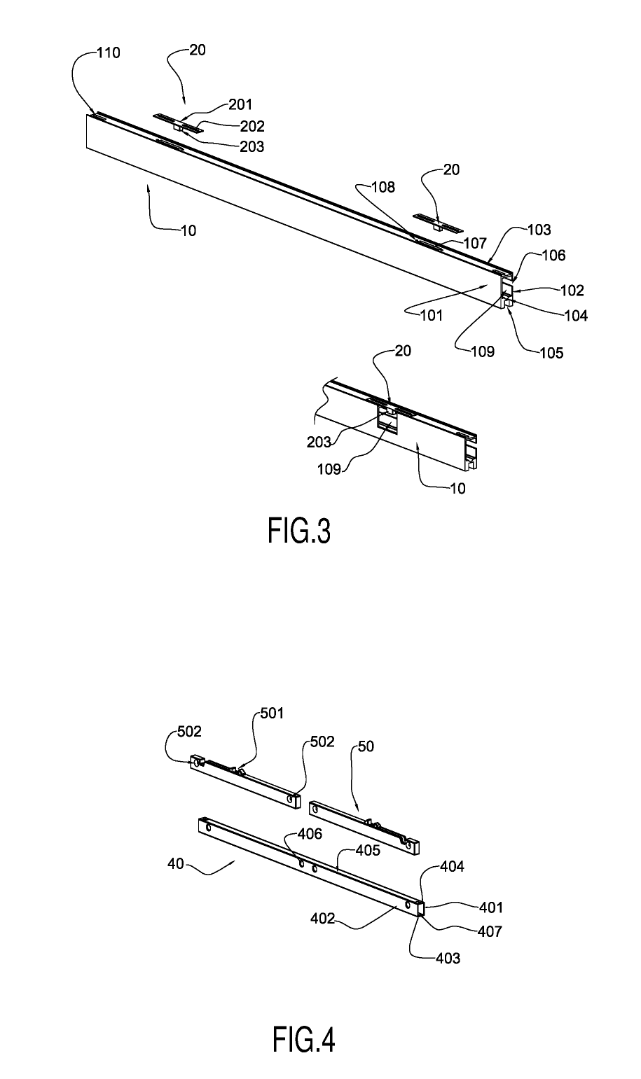

As shown in FIGS. 2 and 3, the rail assembly comprises a rail 10 and two positioning elements 20. For the two positioning elements 20 in FIG. 2, the right positioning element is used for door closing, while the left one is used for door opening. The rail 10 has a sliding channel 109 disposed therein, and the sliding channel 109 is formed into an elongated channel with a substantially rectangular cross-section by the encircling of four rail walls of an upper wall 103, a lower wall 104, a front wall 101 and a rear wall 102, wherein an opening 106 is formed in the rear wall 102. An elongated hole 107 is formed in the upper wall 103, and both ends of the elongated hole 107 are provided with screw holes 108. Both ends of the upper wall 103 are provided with holes 110 that may be connected with a wall or other fixing sheets, and the front wall 101 and the rear wall 102 stretch beyond the lower wall 104 respectively and extend downward to form an open channel 105 that may be configured for mounting the fixed door piece and a waterproof seal, etc. Each of the positioning elements 20 comprises a sheet-like body 201 and a positioning boss 203 extending downward from the middle part of the sheet-like body 201, wherein the sheet-like body 201 is provided thereon with strip holes 202 that are located at both sides of the positioning boss 203. The fixed connection of the positioning elements 20 with the rail 10 can be achieved via the strip holes 202, the screw holes 108 and screws (not shown), and the adoption of the strip holes 202 may facilitate the adjustment of the relative positions of the positioning elements 20 and the rail 10; the sheet-like body 201 is in contact with the upper wall 103 of the rail 10, and the positioning boss 203 extends into the sliding channel 109 of the rail 10 from the elongated hole 107, and can be in contact with the flexible closers 50 on the movable door piece 60.

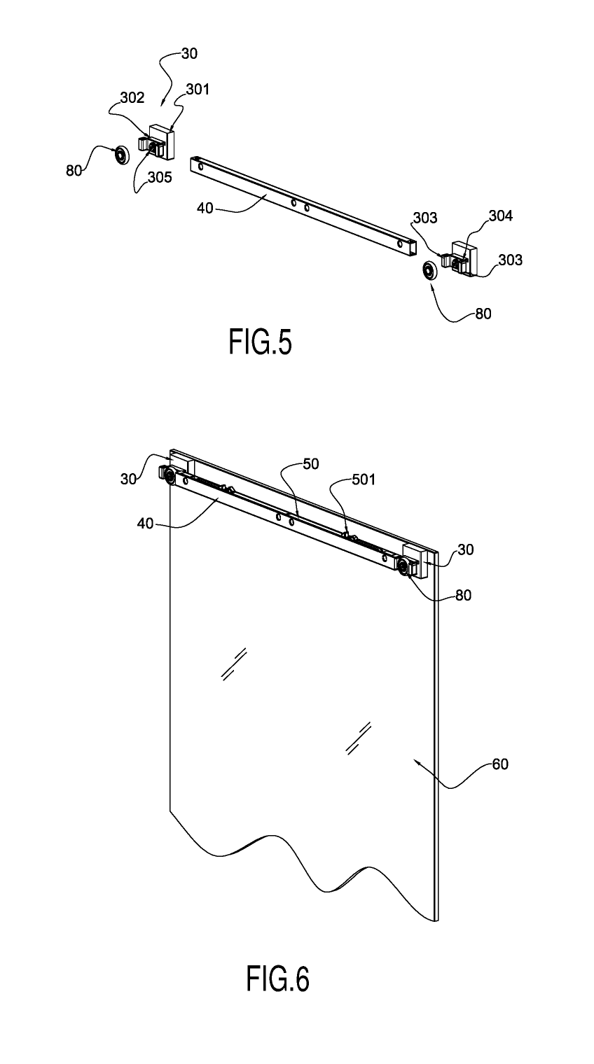

As shown in FIG. 5, the pulley assemblies may be set to be two (or more) in number. Each pulley assembly comprises a pulley base 30 and a pulley 80, wherein the pulley base 30 has a plate-like body 301, a bending plate 302 extends from the surface on one side of the body 301, and the pulley 80 is mounted on the bending plate 302; a screw hole 305 is disposed on the bending plate 302 for mounting the pulley 80. The pulley bases 30 may be fixed on the movable door piece 60 via adhesives, or they may be fixed on the movable door piece 60 through the cooperation of screw and screw hole, etc. Positioning bosses 303 are disposed on the bending plates 302 at both sides of the pulley 80, and mounting holes 304 are disposed on the positioning bosses 303.

As shown in FIG. 4, the flexible closer assembly is composed of a fixing support 40 and two flexible closers 50. For the two flexible closers 50 in FIG. 4, the right flexible closer is used for door closing, while the left one is used for door opening. The flexible closer assembly is mounted between two pulley assemblies, which is in contact with the positioning bosses 303 on the bending plate 302 of the pulley base 30, and fixed by screws. The flexible closer assembly and the pulley 80 on each pulley assembly are movable within the sliding channel 109 of the rail 10, and the bending plate 302 on the pulley base 30 passes through the opening 106 in the rear wall 102 of the rail 10, such that the pulley 80 and the flexible closer assembly are hidden in the sliding channel 109 of the rail 10, and connected with the movable door piece 60 at the opening 106 in the rear wall 102 of the rail 10.

The fixing support 40 is elongated, which is formed into a square tube by the encircling of an upper wall 404, a lower wall 403, a front wall 402 and a rear wall 401, and a cavity is formed within the square tube. A notch 405 is formed in the upper wall 404, and the front wall 402 is provided with holes 406, the flexible closers 50 can be placed into the cavity of the square tube via the notch 405 in the upper wall 404 and fixed with screws. Both ends of the lower wall 403 are provided with holes 407, and ends of the fixing support 40 may be fixed on the bosses 303 of the pulley base 30 via screws.

The holes 50 on the flexible closers 50 are aligned respectively with the corresponding holes 406 on the fixing support 40 so as to achieve the connection of the flexible closers 50 and the fixing support 40. Bayonets 501 are disposed on the top surfaces of the flexible closers 50, and under the action of an external force, the bayonets 501 can achieve dampening movement along the longitudinal direction relative to the bodies of the flexible closers 50. The sizes of the bayonets 501 correspond to those of the positioning bosses 203 of the positioning elements 20. During the movement of the flexible closers 50 relative to the positioning elements 20, when the positioning bosses 203 of the positioning elements 20 are in contact with and coupled to the bayonets 501 of the flexible closers 50, the flexible closers 50 act to achieve buffering and gentle positioning. As flexible closers themselves belong to the prior art, their internal structures and specific working principles are not described herein in detail.

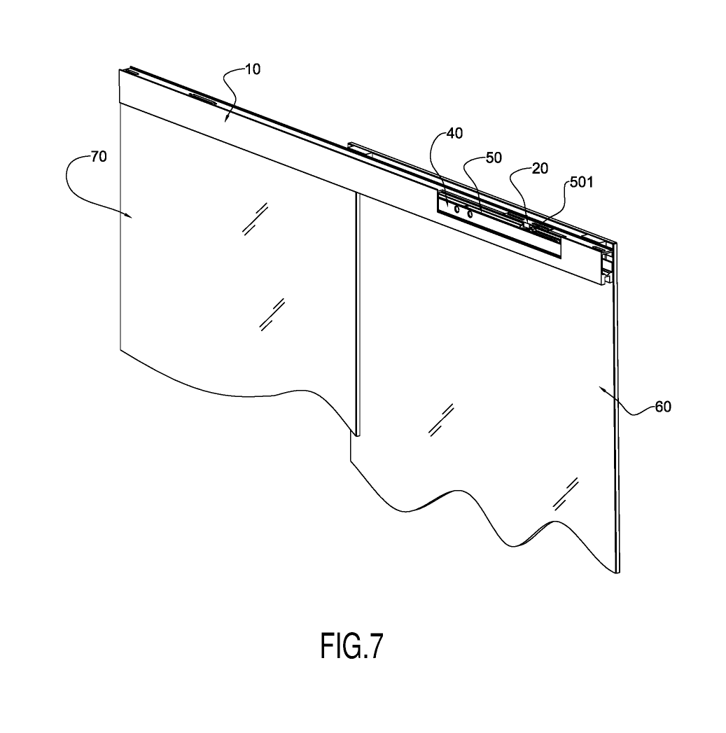

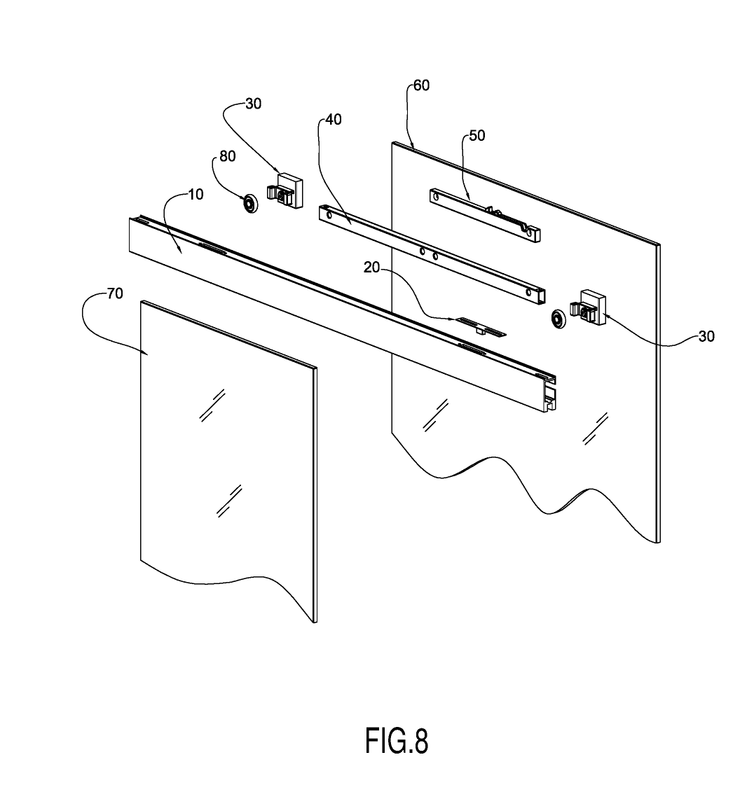

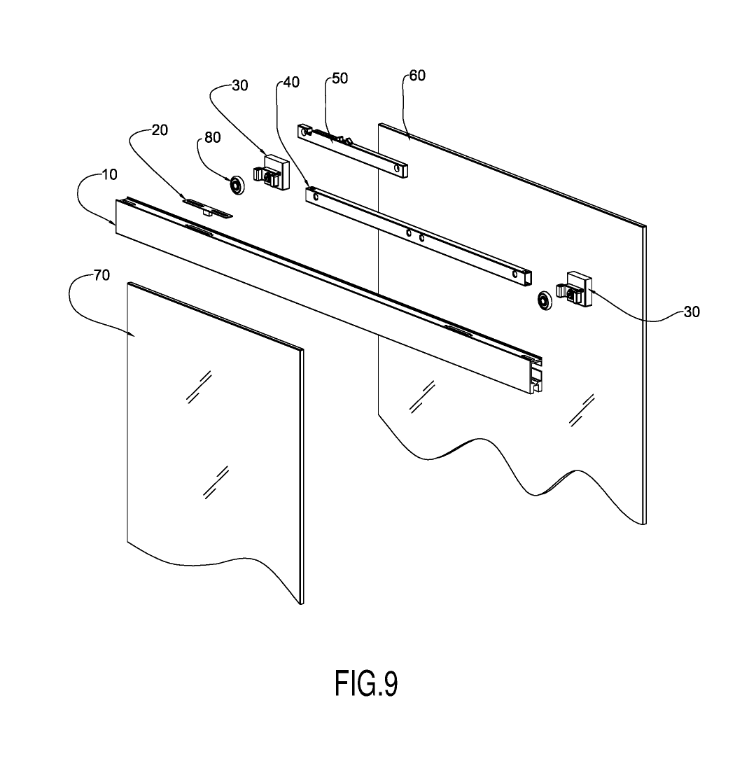

As shown in FIGS. 6 and 7, the flexible closer assembly and the pulley 80 on each pulley assembly move within the sliding channel 109 of the rail 10, and the bending plate 302 on the pulley base 30 passes through the opening 106 in the rear wall 102 of the rail 10, such that the pulley 80 and the flexible closer assembly are hidden in the sliding channel 109 of the rail 10. When the movable door piece 60 moves to a certain position along the closing direction, a bayonet 501 of the flexible closer 50 for door closing will be in contact with and coupled to a positioning boss 203 of the positioning element 20 for door closing mounted on the rail 10 so as to make the flexible closer 50 for door closing act to prevent the movable door piece 60 from moving at a high speed and make it close up automatically at a low speed. Similarly, when the movable door piece 60 is moved by an external force to a certain position along the door opening direction, a bayonet 501 of the flexible closer 50 for door opening will be in contact with and coupled to a positioning boss 203 of the positioning element 20 for door opening mounted on the rail 10 so as to make the flexible closer 50 for door opening act to prevent the movable door piece 60 from moving at a high speed and make it reach the door opening position automatically at a low speed. According to actual needs, it is possible to only dispose the flexible closer for door closing, as shown in FIG. 8; it is also possible to only dispose the flexible closer for door opening, as shown in FIG. 9; the bidirectional gently positioned door opening and closing structure shown in FIG. 2 is certainly more common. Accordingly, the shower door assembly can achieve aesthetically pleasing and impact-free gentle positioning.

Merely preferred embodiments of the present invention have been described above. It should be noted that for those of ordinary skill in the art, several variations and improvements may also be made without departing from the concept of the present invention, and these all fall within the scope of protection of the present invention.

### INDUSTRIAL APPLICABILITY

The completely hidden impact-free gently positioned door opening and closing structure for a shower room in the present invention can be manufactured and used in the industry, and thus possesses industrial applicability.

1. A completely hidden impact-free gently positioned door opening and closing structure for a shower room, comprising: a movable door piece, a rail assembly, a pulley assembly and a flexible closer assembly, wherein the rail assembly comprises a rail having a sliding channel disposed therein, the pulley assembly comprises a pulley base fixed on the movable door piece and a pulley mounted on the pulley base, and the pulley is rollably disposed in the sliding channel;
wherein the flexible closer assembly is fixed to the movable door piece, and movably disposed in the sliding channel; the flexible closer assembly comprises a fixing support and a flexible closer provided with a bayonet, and the flexible closer is fixed on the fixing support; wherein the rail assembly also comprises a positioning element matched with the flexible closer.

2. The door opening and closing structure for the shower room according to claim 1, wherein the sliding channel is formed into an elongated channel with a substantially rectangular cross-section by the encircling of an upper wall, a lower wall, a front wall and a rear wall of the rail, wherein an opening is formed in the rear wall for allowing a bending plate on the pulley base to pass therethrough, an elongated hole is formed in the upper wall for mounting the positioning element, and both ends of the elongated hole are provided with screw holes for fixing the positioning element; both ends of the upper wall are provided with connecting holes for fixing the rail, and the front wall and the rear wall extend downward respectively to form an open channel for mounting a fixed door piece and a waterproof seal.

3. The door opening and closing structure for the shower room according to claim 2, wherein the positioning element comprises a sheet-like body and a positioning boss extending downward from a middle part of the sheet-like body, wherein the sheet-like body is provided thereon with strip holes that are located at both sides of the positioning boss and used for fixing the positioning element to the rail; and the sheet-like body is in contact with the upper wall, and the positioning boss extends into the sliding channel from the elongated hole, and can be in contact with and coupled to the bayonet of the flexible closer.

4. The door opening and closing structure for the shower room according to claim 1, wherein the fixing support is connected and fixed to the pulley base, and located between two of the pulley bases.

5. The door opening and closing structure for the shower room according to claim 4, wherein the pulley base comprises a plate-like body and a bending plate extending from a surface on one side of the body, wherein the pulley is mounted on the bending plate, and a screw hole is disposed on the bending plate for mounting the pulley; and the bending plate is provided with positioning bosses at both sides of the pulley, and mounting holes are disposed in the positioning bosses for connecting the fixing support.

6. The door opening and closing structure for the shower room according to claim 1, wherein the fixing support is elongated, which is formed into a square tube by the encircling of an upper wall, a lower wall, a front wall and a rear wall, and a cavity is formed within the square tube, wherein a notch is formed in the upper wall for placing the flexible closer into the cavity, and a connecting hole is disposed in the front wall for connecting and fixing the flexible closer; and both ends of the fixing support are provided with connecting holes for connecting and fixing the fixing support to the pulley bases.

7. The door opening and closing structure for the shower room according to claim 1, wherein the flexible closer is provided with connecting holes for connecting and fixing to the fixing support, and the bayonet is disposed on the surface of the flexible closer, wherein the size of the bayonet corresponds to that of the positioning bosse of the positioning element, and when the positioning bosse of the positioning element is in contact with and coupled to the bayonet, the flexible closer acts to achieve gentle positioning.

8. The door opening and closing structure for the shower room according to claim 1, wherein the flexible closer comprises a flexible closer for door closing and/or a flexible closer for door opening.

9. The door opening and closing structure for the shower room according to claim 1, wherein the pulley base is fixed on the movable door piece via adhesive or a mechanical fastener.
